(19) United States
(12) Patent Application Publication
(10) Pub. No.: US 2022/0158490 A1
(43) Pub. Date: May 19, 2022

(54) LONG DISTANCE WIRELESS MOBILE PHONE POWER CHARGING DEVICE

(71) Applicant: HSIANG EN HSU, New Taipei City (TW)

(72) Inventor: HSIANG EN HSU, New Taipei City (TW)

(21) Appl. No.: 17/099,790

(22) Filed: Nov. 17, 2020

(51) Int. Cl. H02J 50/10

(52) U.S. Cl. CPC H02J 50/10; H02J 2300/24; H02J 2310/22

(57) ABSTRACT

A long distance wireless mobile phone power charging device comprises a power source for providing electric power; the power source being connected to a power conversion and transmission device; the power conversion and transmission device serving to receive power from the power source and converting the received power into electromagnetic waves for transmitting outwards; the power source containing a battery for power storage; the battery being connected to the power conversion and transmission device; and a receiver which is capable to be connected to a handset; the receiver serving to receive electromagnetic wave emitted from the power conversion and transmission device and then converting the electromagnetic wave into electric current which is further transferred to power cells of the handset; and wherein in power charging, the wireless power charger is placed near the power source; the wireless power charger power supplies power to the power source by electromagnetic induction.

### FIELD OF THE INVENTION

The present invention is related to wireless power charging, and in particular to a long distance wireless mobile phone power charging device.

### BACKGROUND OF THE INVENTION

With the development of technologies, mobile devices, such as handsets, become necessary devices in daily life. Therefore, it is a trend that the handsets are more and more powerful for performing many functions. As a result, the handsets need high power for operations. However, the power of handset is limited and thus it is necessary to be charged after the power is used up. Currently, there are many ways for charging power to handsets, such as wired charging which charges electric power to the handset by wire connection or through connectors. Wireless power charging is developed in that power is charged to the handset wirelessly.

In the prior art charging ways, if the charging is wired, the handset must be connected to the power source; if the charging is wireless, the handset must be near the handset. Therefore, the handset is located in a fixed position. It is unmoved as desired. Furthermore it is often that users must carry mobile power sources in hand. It forms a burden to the users.

Furthermore currently, the power source needs to be charged. To charging the power source forms another burden to the users. The users must keep attention to the power level of the power source. As the power level of the power source is low, the users must charge to the power source, otherwise the power source is unused.

### SUMMARY OF THE INVENTION

Accordingly, for improving above mentioned defects in the prior art, the object of the present invention is to provide a long distance wireless mobile phone power charging device, wherein a power conversion and transmission device serves to transfer power from the power source. The waves emitted from the power source is received by the receiver combined with the handset and is converted into current for charging the handset. By the structure of the present invention, the handset can be placed in far end and can be moved within the transmission space of the electromagnetic wave emitted from the handset. It is very convenient for the user of the handset. The user's location is unconfined. Furthermore solar plates are added to the power source and thus the power source can be charged anytime only that the environment has sufficient light. Thus the cost in charging is very low and charging of the power source is convenient.

To achieve above object, the present invention provides a long distance wireless mobile phone power charging device comprises a power source for providing electric power; the power source being connected to a power conversion and transmission device; the power conversion and transmission device serving to receive power from the power source and converting the received power into electromagnetic waves for transmitting outwards; the power source containing a battery for power storage; the battery being connected to the power conversion and transmission device; and a receiver which is capable to be connected to a handset; the receiver serving to receive electromagnetic wave emitted from the power conversion and transmission device and then converting the electromagnetic wave into electric current which is further transferred to power cells of the handset; and wherein in power charging, the wireless power charger is placed near the power source; the wireless power charger power supplies power to the power source by electromagnetic induction.

### BRIEF DESCRIPTION OF THE DRAWINGS

FIG. 1 is an assembled schematic view showing the elements of the present invention.

FIG. 2 is a schematic view showing the wireless charging according to the present invention.

FIG. 3 is an exploded schematic view about the receiver and the handset of FIG. 1.

FIG. 4 is another assembled schematic view according to the present invention.

FIG. 5 shows the detail structure of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

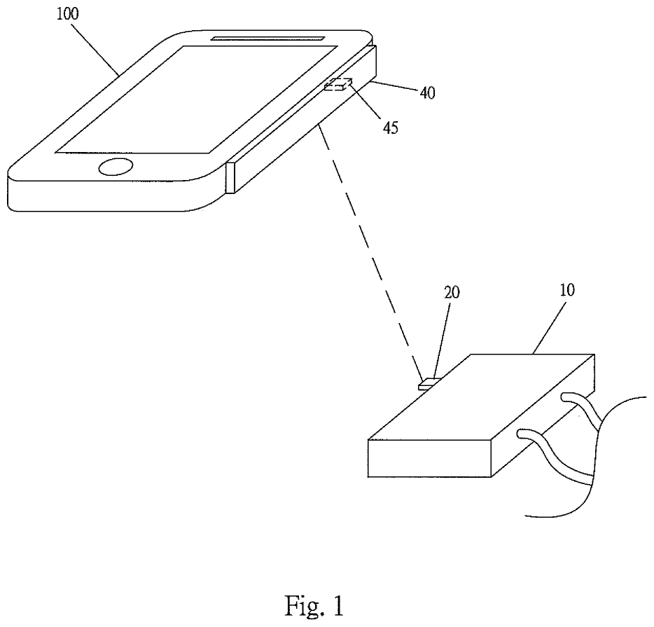

With reference to FIGS. 1 to 5, the structure of the present invention is illustrated. The present invention includes the following elements.

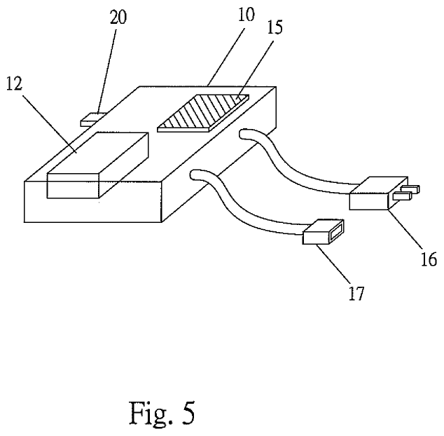

A power source 10 serves for providing electric power. The power source 10 is connected to a power conversion and transmission device 20. The power conversion and transmission device 20 serves to receive power from the power source 10 and converts the received power into electromagnetic waves for transmitting outwards. The power source 10 contains a battery 12 for power storage. The battery 12 is connected to the power conversion and transmission device 20 as illustrated in FIG. 5.

The power source 10 is further installed with a plug 16 for power supply. The plug 16 is a general used plug 16 for connecting to an outside electric source or a USB plug 16.

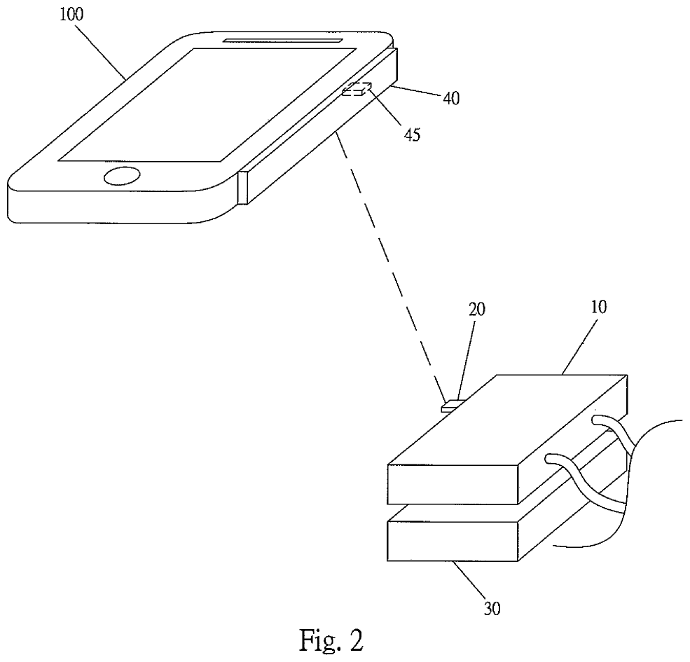

Or the power source 10 is charged by a wireless power charger 30 for charging power to the power source 10 wirelessly, as illustrated in FIG. 2.

In power charging, the wireless power charger 30 is placed near the power source 10. The wireless power charger 30 power supplies power to the power source 10 by electromagnetic induction.

Furthermore the power source 10 may be installed with a solar plate 15 for absorbing light power and converting the light power into electric power which is further stored in the battery 12 of the power source 10.

A receiver 40 is included. In use, the receiver 40 is connected to a handset 100. The receiver 40 serves to receive electromagnetic wave emitted from the power conversion and transmission device 20 and then converts the electromagnetic wave into electric current which is further transferred to power cells (not shown) of the handset 100.

Preferably, the receiver 40 is distanced from the power source 10 with a distance between 1 meter to 50 meters.

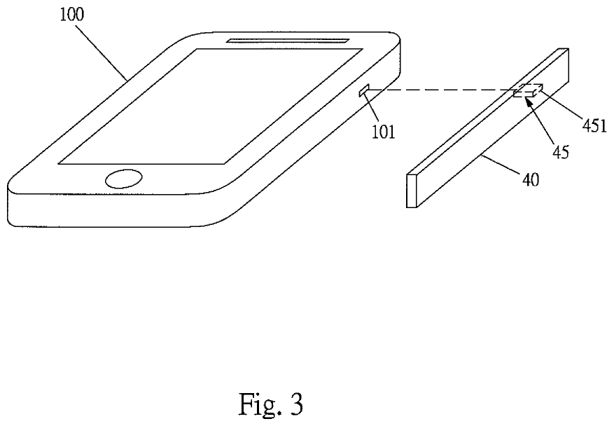

The receiver 40 can be connected at one side of the handset 100 (referring to FIG. 1) and is inserted into a power charging hole of the handset 100 so that the current in the receiver 40 can be transferred to the handset 100. The receiver 40 contains a connection unit 45 for being connected to the power charging hole of the handset 100k. Preferably, the connection unit 45 is a USB connector 451 which serves to be connected to a USB port 101 of the handset 100 (referring to FIG. 3).

Referring to FIG. 1, preferably, the receiver 40 is an expanded transversal structure which has a shape matched to that of the handset 100 so that when the receiver 40 is combined to the handset 100. The two are formed as an integral structure and have a beautiful outlook.

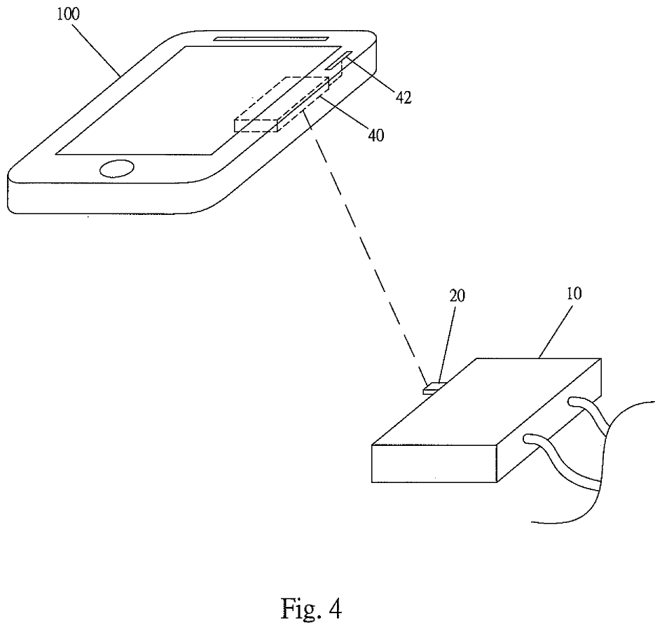

Furthermore, in the present invention, the receiver 40 can be installed within the handset 100 (referring to FIG. 4), and a surface or a preset position of the handset 100 is formed with an electromagnetic induction unit 42 for receiving electromagnetic wave transmitted from the power conversion and transmission device 20. Therefore, by this structure, the receiver 40 and the handset 100 are formed as an integral structure.

The present invention further includes a handset APP (Application). When the handset APP is downloaded to the handset 100, the charge of the handset 100 is controlled thereby. By the APP, the actuation of the receiver 40 is controlled by the APP and a pass word is necessary for actuation.

In use, the output current of the power source 10 flows through the power conversion and transmission device 20 so as to be converted into electromagnetic wave for transfer. Then the far end receiver 40 will receive the electromagnetic wave and converts as current which is further transferred into the electric cells of the handset 100. Thus the power is charged to the handset 100 from the far end power source 10.

Therefore, the power source 10 is located at one place, and the current from the power source 10 is converted into electromagnetic wave by the power conversion and transmission device 20 and then the wave is transmitted in the space. Preferably, the power source 10 is located indoors. When the handset 100 is placed within the space, the receiver 40 will receive the electromagnetic wave and then converts the wave into current for charging to the cells of the handset 100. Thus, the handset 100 is unnecessary to contact with the power source 10. Even the user holding the handset 100 walks around the space, the handset 100 can still be charged.

Advantages of the present invention are that the power conversion and transmission device serves to transfer power from the power source. The waves emitted from the power source is received by the receiver combined with the handset 100 and is converted into current for charging the handset. By the structure of the present invention, the handset can be placed in far end and can be moved within the transmission space of the electromagnetic wave emitted from the handset. It is very convenient for the user of the handset. The user's location is unconfined. Furthermore solar plates are added to the power source and thus the power source can be charged anytime only that the environment has sufficient light. Thus the cost in charging is very low and charging of the power source is convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A long distance wireless mobile phone power charging device, comprising:
a power source for providing electric power; the power source being connected to a power conversion and transmission device; the power conversion and transmission device serving to receive power from the power source and converting the received power into electromagnetic waves for transmitting outwards; the power source containing a battery for power storage; the battery being connected to the power conversion and transmission device; and
a receiver which is capable to be connected to a handset; the receiver serving to receive electromagnetic wave emitted from the power conversion and transmission device and then converting the electromagnetic wave into electric current which is further transferred to power cells of the handset; and
wherein in power charging, the wireless power charger is placed near the power source; the wireless power charger power supplies power to the power source by electromagnetic induction.

2. The long distance wireless mobile phone power charging device as claimed in claim 1, wherein the power source is installed with a plug for power supply.

3. The long distance wireless mobile phone power charging device as claimed in claim 2, wherein the plug is a general used plug for connecting to an outside commercial used electric source from power plants.

4. The long distance wireless mobile phone power charging device as claimed in claim 2, wherein the plug is a USB plug.

5. The long distance wireless mobile phone power charging device as claimed in claim 1, wherein the power source is charged by a wireless power charger for charging power to the power source wirelessly.

6. The long distance wireless mobile phone power charging device as claimed in claim 1, wherein the power source is installed with a solar plate for absorbing light power and converting the light power into electric power which is further stored in the battery of the power source.

7. The long distance wireless mobile phone power charging device as claimed in claim 1, wherein the receiver is an expanded transversal structure which has a shape matched to that of the handset so that when the receiver is combined to the handset; the two are formed as an integral structure.

8. The long distance wireless mobile phone power charging device as claimed in claim 1, wherein the receiver is installed within a handset, and a surface or a preset position of the handset is formed with an electromagnetic induction unit for receiving electromagnetic wave transmitted from the power conversion and transmission device.

9. The long distance wireless mobile phone power charging device as claimed in claim 1, further comprising: a handset APP; when the handset APP is downloaded to the handset, the charge of the handset is controlled thereby; by the APP, the actuation of the receiver is controlled by the APP and a pass word is necessary for actuation.

10. The long distance wireless mobile phone power charging device as claimed in claim 1, wherein the receiver is distanced from the power source with a distance between 1 meter to 50 meters.
